(19) United States
(12) Patent Application Publication
(10) Pub. No.: US 2026/0185243 A1
(43) Pub. Date: Jul. 2, 2026

(54) METHOD OF MANUFACTURING A SINTERED STEPPED POROUS TRANSPORT LAYER FOR AN ELECTROCHEMICAL CELL

(71) Applicant: Robert Bosch GmbH, Stuttgart (DE)

(72) Inventors: Jonathan BRAATEN, Sunnyvale, CA (US); Lei CHENG, Sunnyvale, CA (US); Shirin MEHRAZI, San Jose, CA (US); Felipe MOJICA, Sunnyvale, CA (US); Bjoern STUEHMEIER, Santa Clara, CA (US)

(21) Appl. No.: 19/003,425

(22) Filed: Dec. 27, 2024

(51) Int. Cl. C25B 11/032; H01M 8/0232; H01M 8/0236

(52) U.S. Cl. CPC C25B 11/032; H01M 8/0232; H01M 8/0236

(57) ABSTRACT

A method of manufacturing a porous transport layer (PTL) for an electrochemical cell may include filling a sintering bed with a powder substance, wherein the sintering bed has a top face profile, and applying heat to the sintering bed and the powder substance to form the PTL from the powder substance, the PTL having a first thickness in a first region and a second thickness in a second region, the first thickness is greater than the second thickness.

### TECHNICAL FIELD

The present disclosure relates to an apparatus and method of manufacturing a porous transport layer (PTL) with a stepped profile for an electrochemical cell. The stepped profile providing regional decreased porosity and improved interfacial stability.

### BACKGROUND

An electrochemical cell such as an electrolysis cell is configured to electrolyze water into hydrogen and oxygen. Water electrolysis is a promising source for green hydrogen to usher in an energy transition toward fully renewable energy consumption. One type of electrolysis cell is a proton exchange membrane electrolysis cell (PEMEC).

PEMECs may use expensive and scarce electrode catalyst materials and corrosion resistant but less conductive materials in their operation. The current utilization of these materials may lead to local current and degradation hot spots within the PEMEC, thereby reducing the efficiency and lifetime of the PEMEC. Further, these materials may be unevenly used or underutilized during PEMEC operation, leading to higher loadings than are necessary with a properly distributed and/or utilized catalyst.

### SUMMARY

A method of manufacturing a porous transport layer (PTL) for an electrochemical cell may include filling a sintering bed with a powder substance, wherein the sintering bed has a top face profile, and applying heat to the sintering bed and the powder substance to form the PTL from the powder substance, the PTL having a first porosity in a first region and a second porosity in a second region, the first porosity is greater than the second porosity.

In another embodiment, the porous transport layer (PTL) sintering bed may include a first dimensional layer thickness, and a second dimensional layer thickness, the first dimensional layer thickness and the second dimensional layer thickness are cooperatively configured to form a PTL with a perimeter edge thickness less than a center portion thickness of the PTL.

A method of manufacturing a porous transport layer (PTL) for an electrochemical cell may include filling a sintering bed with a powder substance, wherein the sintering bed has a top face profile, and applying heat to the sintering bed and the powder substance to form the PTL from the powder substance, the PTL having a first thickness in a first region and a second thickness in a second region, the first thickness is greater than the second thickness.

The sinter bed may have a stepped edge that is configured to form a transition between the first region and the second region, and the transition is stepwise, slanted, linear, curved, or filleted.

### BRIEF DESCRIPTION OF THE DRAWINGS

FIG. 1 is a cross sectional view of a proton exchange membrane electrolysis cell (PEMEC) depicting a porous transport layer (PTL) in an exemplary electrochemical cell.

FIG. 2 is a cross sectional view of a proton exchange membrane electrolysis cell (PEMEC) depicting a porous transport layer (PTL) in an exemplary electrochemical cell.

FIG. 3 is a cross sectional view of a proton exchange membrane electrolysis cell (PEMEC) depicting a porous transport layer (PTL) in an exemplary electrochemical cell.

FIG. 4 is a cross sectional view of a proton exchange membrane electrolysis cell (PEMEC) depicting a transitional profile porous transport layer (PTL) in an exemplary electrochemical cell.

FIG. 5 is a cross sectional view of a proton exchange membrane electrolysis cell (PEMEC) depicting a transitional profile porous transport electrode (PTE) in an exemplary electrochemical cell.

FIG. 6A is cross sectional view of a porous transport layer (PTL) illustrating a stepped transition.

FIG. 6B is cross sectional view of a porous transport layer (PTL) illustrating a linear transition.

FIG. 6C is cross sectional view of a porous transport layer (PTL) illustrating a concave transition.

FIG. 6D is cross sectional view of a porous transport layer (PTL) illustrating a filleted bottom edge transition.

FIG. 7 is a perspective view of a compression die press for stepped porous transport layer (PTL) manufacturing.

FIG. 8 is a perspective view of a sintering bed for stepped porous transport layer (PTL) manufacturing.

FIG. 9 is a perspective view of a stepped punch press for stepped porous transport layer (PTL) manufacturing.

FIG. 10 is a perspective view of a fabricated stepped porous transport layer (PTL) having a compressed region and a porous region.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. These terms may be used to modify any numeric value disclosed or claimed herein. Generally, the term “about” denoting a certain value is intended to denote a range within ±5% of the value. As one example, the phrase “about 100” denotes a range of 100±5, i.e., the range from 95 to 105. Generally, when the term “about” is used, it can be expected that similar results or effects according to the invention can be obtained within a range of ±5% of the indicated value. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1 to 10 explicitly includes 1, 2, 3, 4, 5, 6, 7, 8, 9, and 10. Similarly, the range 1 to 100 includes 1, 2, 3, 4, . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

As used herein, the term “and/or” means that either all or only one of the elements of said group may be present. For example, “A and/or B” means “only A, or only B, or both A and B”. In the case of “only A”, the term also covers the possibility that B is absent, i.e., “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Description of constituents in chemical terms refers to the constituents at the time of addition to any combination specified in the description and does not necessarily preclude chemical interactions among constituents of the mixture once mixed. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Poor surface contact between a porous transport layer (PTL) of an electrolysis cell (e.g., a proton exchange membrane electrolysis cell (PEMEC)) and an anode catalyst layer of the electrolysis cell may result in inefficient utilization of the anode catalyst material. The anode catalyst material may be comprised of a precious metal material. The poor surface contact may also lead to accelerated localized degradation at contacted spots between the PTL and the anode catalyst layer. Further, a high-pressure differential between the electrodes of the electrolysis cell (i.e., anode and cathode) may induce mechanical stresses. These mechanical stresses may result in catalyst exfoliation and/or deformation of the interface between the PTL, the anode and the polymer electrolyte membrane (PEM) of the electrolysis cell.

In one or more embodiments, an electrolysis cell is disclosed that increases contacting surface area between the PTL and the anode catalyst layer and/or reduces mechanical stresses within the electrolysis cell (e.g., between the catalyst layer, membrane, and the PTL). The electrolysis cell may include an anode catalyst layer (e.g., a surface decoration) deposited on a PTL surface morphology with or without a microporous layer (MPL) to form a porous transport electrode (PTE). The electrolysis cell may further include ionomer material infiltrating the PTE surface morphology (e.g., directly contacting the distributed catalyst layer). The infiltrating ionomer material may infiltrate into the pores between the PEM and the anode catalyst layer supported on the PTL.

Although this Stepped PTL is shown for a electrolysis cell, this can also be implemented as a stepped GDL (gas diffusion layer) in a fuel cell although the stepped function is not necessary for GDLs as by nature they are deformable and make this stepped shape without preprocessing. The preprocessing may be of benefit to reduce issues due to compression during assembly. Further, the concepts here of a stepped PTL may be utilized in an electrochemical hydrogen pump in which the compression of hydrogen is performed with hydrogen on both sides but having a pressure gradient between both sides. In summary, this stepped layer would benefit multiple electrochemical systems including electrolysis, fuel cell, SOFC, H₂ compression, AEM, etc.

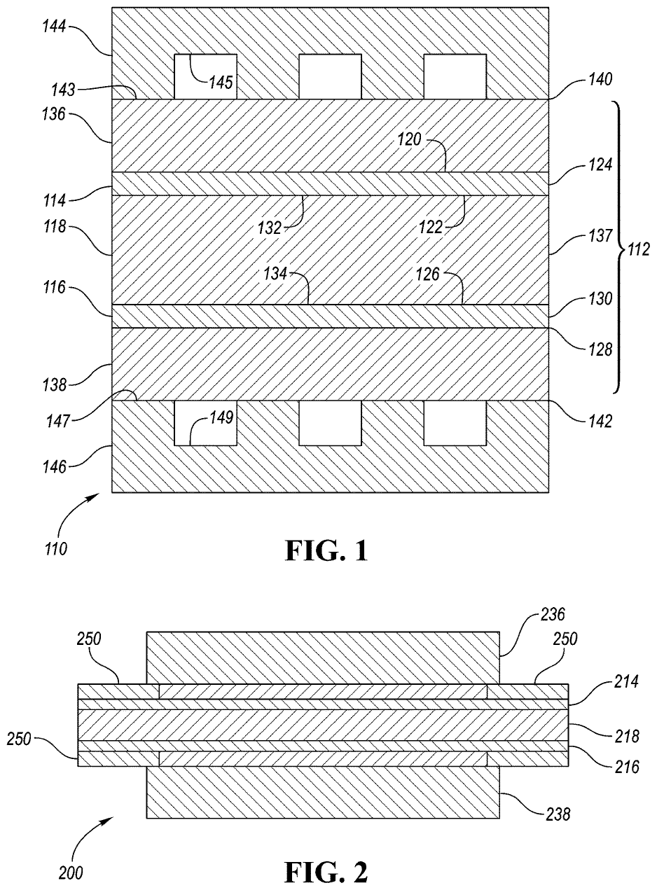

FIG. 1 is a schematic, cross sectional view of a proton exchange membrane electrolysis cell (PEMEC) 110 highlighting limited contact points between a porous transport layer (PTL) and an anode catalyst layer that may result in local current and degradation hot spots. FIG. 2 depicts a schematic, cross sectional view of PEMEC 110 highlighting limited contact points between a PTL and a flow field plate or current collector that may result in local current and degradation hot spots.

PEMEC 110 may be stacked to create a PEMEC stack or system. PEMEC 110 includes membrane electrode assembly (MEA) 112. MEA 112 includes anode catalyst layer 114, anode porous transport layer (PTL) 136 with or without a microporous layer (MPL) (or mesoporous layer), cathode catalyst layer 116, cathode gas diffusion media (GDM) 138, and proton conducting membrane 118 sandwiched between anode catalyst layer 114 and cathode catalyst layer 116. Anode catalyst layer 114 and cathode catalyst layer 116 are separated by proton conducting membrane 118.

In FIG. 1, the PEMEC 110 includes flow field plate 144 having lands and channels 145 forming a flow field of PEMEC 110. While FIG. 1 depicts a flow field plate, this and other embodiments may be applied to any type of current collector (e.g., collector plates, flow mesh, flow fields, flow structures, and/or bipolar plates).

As part of the operation of PEMEC 110, an oxygen evolution reaction (OER) occurs at anode catalyst layer 114 and a hydrogen evolution reaction (HER) occurs at cathode catalyst layer 116 with H⁺ ions (protons) flowing through the proton conducting membrane 118 from anode catalyst layer 114 to cathode catalyst layer 116.

Anode catalyst layer 114 may include an anode catalyst material supported on an anode catalyst support. Cathode catalyst layer 116 may include a cathode catalyst material supported on a cathode catalyst support. The cathode catalyst material may include but is not limited to platinum deposited on a carbon support. The anode catalyst material may include iridium (Ir), iridium oxide (IrOₓ), where x is in a range of 2 to 4, ruthenium (Ru), ruthenium oxide (RuOₓ), where x is in a range of 1.8 to 2.2, TiO₂, ZrO₂, WOₓ, where x is in a range of 1 to 6 suboxides thereof or a combination thereof. Furthermore, the anode material may include Ir- and Ru-alloy materials that may also include Pt, Au, or Pd. And in an embodiment of an alkaline electrolysis system, may include Ni, Fe, and steel and mixtures thereof. In one or more embodiments, the anode catalyst material is configured to combat the acidic environment of PEMEC 110, the sluggish kinetics of the OER, and/or the presence of highly corrosive anode potentials (>1.5V). The anode support material may be formed of titanium (Ti), titanium oxide (TiO₂), zirconium (Zr), zirconium oxide (ZrO₂), tungsten (W), tungsten oxide (WO₆), alloys thereof, or a combination thereof. Anode catalyst layer 114 and/or cathode catalyst layer 16 may include a catalyst material, a catalyst support, and an ionic polymer or ionomer binder. The anode and/or cathode may be referred to as the electrodes of PEMEC 110. In one or more embodiments, the electrodes have primary and secondary pores in a range of less than 1 μm. Proton conducting membrane 18 may be a polymer electrolyte membrane (PEM) including an ionomer material. The ionomer material includes an ionomer and optionally a filler (e.g., silica nanospheres, polytetrafluoroethylene (PTFE) reinforcement, radical scavengers, and/or recombination catalysts). The ionomer may be perfluorinated sulfonic acid ionomer, a high oxygen permeable ionomer, a hydrocarbon ionomer, an ion conducting polymer, or a combination thereof.

Anode catalyst layer 114 includes first surface 120 also referred to as an anode top surface and second surface 122 also referred to as an anode bottom surface and bulk region 124 extending therebetween. Cathode catalyst layer 116 includes first surface 126 and second surface 128 and bulk region 130 extending therebetween. Proton conducting membrane 118 includes first surface 132 and second surface 134 and bulk region 137 extending therebetween. In one or more embodiments, second surface 122 of anode catalyst layer 114 contacts first surface 132 of proton conducting membrane 118. In one or more embodiments, second surface 134 of proton conducting membrane 118 contacts first surface 126 of cathode catalyst layer 116.

As shown in FIG. 1, first side 140 and second side 142 of MEA 112 are bounded by first flow field plate 144 and second flow field plate 146, respectively. Flow fields may also be described as current collectors. First flow field plate 144 includes a network of lands 143 and channels 145. The lands 143 are proximate to the PTL 136 at a PTL first surface also referred to as a PTL top surface and the anode catalyst layer 114 first surface 120 is proximate to a second surface of the PTL also referred to as an PTL bottom surface.

Second flow field plate 146 includes a network of lands 147 and channels 149. In one or more embodiments, first flow field plate and second flow field plate 146 have macroscale channels of the flow field plate formed by the lands and channels having a width in a range of 0.1 to 10.0 mm.

MEA 112 also includes PTL 136 and gas diffusion media (GDM) 138. As shown in FIG. 1, PTL 136 is adjacent first surface 120 of anode catalyst layer 114, and GDM 138 is adjacent second surface 128 of cathode catalyst layer 116. PTL 136 may be formed of titanium (Ti), titanium oxide (TiO₂), a titanium alloy, or a combination thereof. Similar to the anode support material, the PTL may be formed of titanium (Ti), titanium oxide (TiO₂), zirconium (Zr), zirconium oxide (ZrO₂), tungsten (W), tungsten oxide (WO₆), alloys thereof, or a combination thereof. PTL 136 is configured to transport reactants and products (i.e., water and O₂) between anode catalyst layer 114 and first flow field plate 144. Further the PTL mechanically supports the pressure differential across the MEA 112. In one or more embodiments, PTL 136 is configured to bridge the gap between the microscale pores of anode catalyst layer 114 and the macroscale channels of first flow field plate 144.

The anode catalyst layer may be deposited as a continuous thin film of less than 25 μm in thickness on the proton conducting membrane. While the anode catalyst layer includes anode catalyst particles that are typically smaller than 0.5 μm, the PTL structure includes pores of several tens of μm in size (e.g., 10 to 50 μm). As a result, only a small fraction of the anode catalyst layer directly contacts the PTL.

FIG. 2 is a cross sectional view of a proton exchange membrane electrolysis cell (PEMEC) depicting a porous transport layer (PTL) in an exemplary electrochemical cell membrane electrode assembly (MEA) 200. Similar to FIG. 1, in this embodiment there is an anode catalyst layer 214 and a cathode catalyst layer 216 with a polymer electrolyte membrane (PEM) 218 therebetween. The PTL 236 adjacent to the anode catalyst layer 214 with an anode active area at the interface. Also a gas diffusion media (GDM) 238 adjacent to the cathode catalyst layer 216 with a cathode active area at the interface. The anode catalyst layer 214, cathode catalyst layer 216, and membrane 218 therebetween are held in place by a frame 250. In this embodiment, the PTL 236 rests on-top of the frame 250 such that the anode active area is approximately equal to the width of the frame 250.

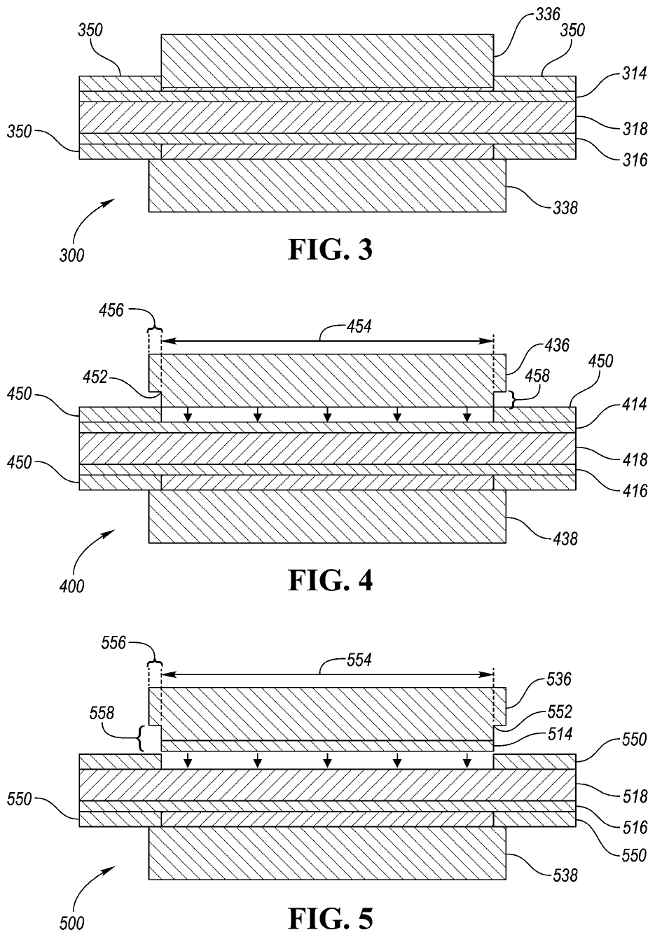

FIG. 3 is a cross sectional view of a proton exchange membrane electrolysis cell (PEMEC) depicting a porous transport layer (PTL) in an exemplary electrochemical cell membrane electrode assembly (MEA) 300. Similar to FIG. 1, in this embodiment there is an anode catalyst layer 314 and a cathode catalyst layer 316 with a polymer electrolyte membrane (PEM) 318 therebetween. The PTL 336 adjacent to the anode catalyst layer 314 with an anode active area at the interface. Also, a gas diffusion media (GDM) 338 adjacent to the cathode catalyst layer 316 with a cathode active area at the interface. The anode catalyst layer 314, cathode catalyst layer 316, and membrane 318 therebetween are held in place by a frame 350. In this embodiment, the PTL 336 rests between the frame 350 such that the anode active area is at the interface between the PTL 336 adjacent to the anode catalyst layer 314.

FIG. 4 is a cross sectional view of a proton exchange membrane electrolysis cell (PEMEC) depicting a transitional profile porous transport layer (PTL) in an exemplary electrochemical cell membrane electrode assembly (MEA) 400. Similar to FIG. 1, in this embodiment there is an anode catalyst layer 414 and a cathode catalyst layer 416 with a polymer electrolyte membrane (PEM) 418 therebetween. The PTL 436 adjacent to the anode catalyst layer 414 with an anode active area at the interface. Also, a gas diffusion media (GDM) 238 adjacent to the cathode catalyst layer 416 with a cathode active area at the interface. The anode catalyst layer 414, cathode catalyst layer 416, and membrane 418 therebetween are held in place by a frame 450. In this embodiment, the PTL 436 includes a step profile 452 such that a first portion 454 of the PTL is situated between the frame 450 thereby closer to the Anode Catalyst layer 414 and a second portion 456 of the PTL rests on the frame 450. The anode active area is at the interface between the PTL 436 adjacent to the anode catalyst layer 414. The stepped PTL 436 has a transition 452 separating the first portion 454 with the second portion 456 and the first portion 454 has a step distance 458 that is approximately equal to the frame opening width 450.

A stepped porous transport layer PTL with deposited electrode (porous transport electrode, PTE) is disclosed for mitigation of stresses and damage to the membranes included in water electrolysis membrane electrode assemblies or MEAs. The stepped structure is designed to reduce contact resistances between the PTE's anode catalyst layer and the membrane, provide mechanical support for the membrane under high pressure operation, and eliminate damage to the membrane and catalyst layers at the edge of the PTL/PTE.

In porous transport electrodes or PTEs, in which the anode electrode is deposited directly on the PTL prior to assembly into an MEA, the ionic pathway between the anode catalyst layer ionomer phase and the membrane is crucial to low resistance. To address this and other concerns, a modified PTE in a stepped configuration to mechanically stabilize the membrane and eliminate burr effects while enhancing contact between the anode catalyst layer of the PTE and the membrane is disclosed.

The stepped-PTL/PTE structure combines the benefits of previous approaches of FIGS. 1, 2, and 3 while mitigating the drawbacks of each. The stepped edges and burrs of the PTL/PTE are mechanically supported by the CCM, reducing the stress on the anode/membrane/cathode assembly and preventing pinholes, while the unmodified middle section of the PTL/PTE with the anode catalyst layer applied is placed in direct contact with the anode membrane, reducing contact resistances between the ionomer phase of the anode catalyst layer and the membrane.

As shown in FIG. 4, the transition between the compressed part of the PTL/PTE can be a direct step (A), a transition with a defined angle (B), or rounded transition (C). A gradual transition would allow for a higher manufacturing tolerance as the PTL would slide into the right position upon compression. Furthermore, the edges can be rounded (D). Any combination of shapes A, B, C, and D is possible.

FIG. 5 is a cross sectional view of a proton exchange membrane electrolysis cell (PEMEC) depicting a transitional profile porous transport electrode (PTE) in an exemplary electrochemical cell membrane electrode assembly (MEA) 500. Similar to FIG. 1, in this embodiment there is an anode catalyst layer 514 and a cathode catalyst layer 516 with a membrane 518 therebetween. The PTL 536 has the anode catalyst layer 514 integrated with it to form a PTE with an anode active area at the interface between the PTE and the membrane 518. Also, a gas diffusion media (GDM) 538 adjacent to the cathode catalyst layer 516 with a cathode active area at the interface. The cathode catalyst layer 516, and membrane 518 therebetween are held in place by a frame 550. In this embodiment, the PTL 536 includes a step profile 552 such that a first portion 554 of the PTL is situated between the frame 550 thereby closer to the Anode Catalyst layer 514 and a second portion 556 of the PTL rests on the frame 550. The stepped PTL 536 has a transition 552 separating the first portion 554 with the second portion 556 and the first portion 554 has a step distance 558 that is approximately equal to the frame 550 width.

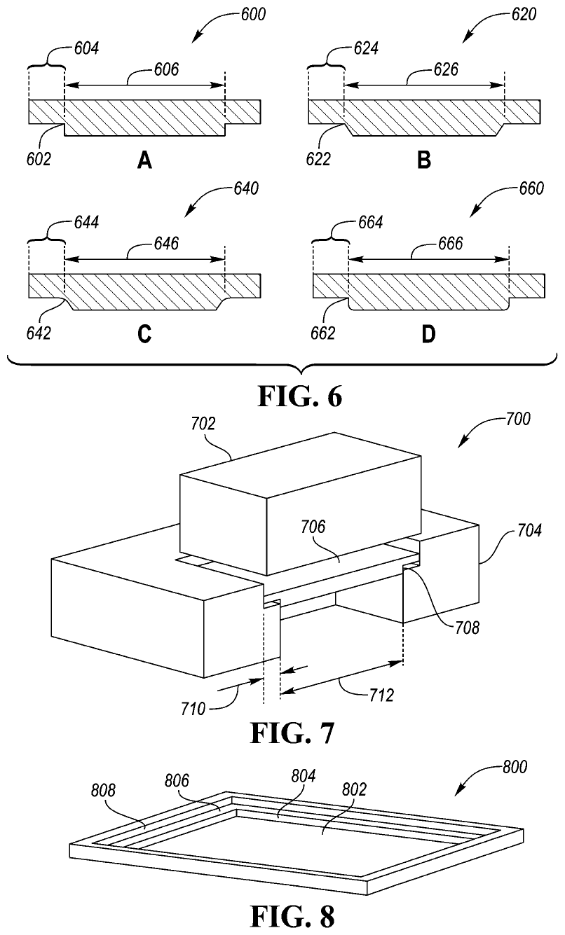

FIG. 6A is cross sectional view of a porous transport layer (PTL) 600 illustrating a stepped transition 602 between a first portion 606 and a second portion 604 of the PTL. This stepped transition 602 may be perpendicular with respect to the PTL first and second surface. This stepped transition may be filleted on the bottom to aid in assembly and alignment. This cross-sectional view can also be used to illustrate a porous transport electrode (PTE).

FIG. 6B is cross sectional view of a porous transport layer (PTL) 620 illustrating a linear transition 622 between a first portion 626 and a second portion 624 of the PTL. This stepped transition 622 may be angled with respect to the PTL first and second surface. This stepped transition may be slanted such that bottom in narrower than the top to aid in assembly and alignment. This cross-sectional view can also be used to illustrate a porous transport electrode (PTE).

FIG. 6C is cross sectional view of a porous transport layer (PTL) 640 illustrating a concave transition 642 between a first portion 646 and a second portion 644 of the PTL. This stepped transition 642 may be concave with respect to the PTL first and second surface. This stepped transition may be filleted on the bottom along with the concave transition surface to aid in assembly and alignment. This cross-sectional view can also be used to illustrate a porous transport electrode (PTE).

FIG. 6D is cross sectional view of a porous transport layer (PTL) illustrating a convex transition 662 between a first portion 666 and a second portion 664 of the PTL. This stepped transition 662 may be bottom edge fillet with respect to the PTL first and second surface. This stepped transition may be filleted on the bottom to aid in assembly and alignment. This cross-sectional view can also be used to illustrate a porous transport electrode (PTE).

A method of fabricating a stepped porous transport layer or PTL is disclosed for mitigation of stresses and damage to critical catalyst layers and membranes included in water electrolysis membrane electrode assemblies or MEAs. The stepped structure is designed to reduce contact resistances between the anode catalyst layer and the PTL/PTE, provide mechanical support for the membrane under high pressure operation, and eliminate damage to the membrane and catalyst layers at the edge of the PTL/PTE. The proposed method includes post-processing steps, including pressing of the edges of the cut PTL between a compression block and a base die, resulting in an edge thickness less than that of the uncompressed center area.

The transition between the compressed part of the PTL can be a direct step (FIG. 6A), a transition with a defined angle (FIG. 6B), or concave rounded transition (FIG. 6C). A gradual transition would allow for a higher manufacturing tolerance as the PTL would slide into the right position upon compression. Furthermore, the edges can be convex rounded (FIG. 6D).

A method of creating the porous transport layer (PTL) includes a compression block and base die that may be used in a press. In this configuration, the as-cut PTL is placed between the compression block and the base die and pressed until the PTL deformation achieves the target depth, for example between 0 and 1, 2, 3, 4, 5, 6, 7, 8, 9, 10, 11, 12, 13, 14, 15, 20 mm. The deformation can be performed homogeneously for the whole perimeter of the PTL or compress certain sections more than others. This could be done to accommodate pressure distribution requirements of the stack, e.g., if the corners of the active area require a different thickness/compression than the middle of the edge, or to form water flow distribution channels that allow for a targeted distribution of the water flow.

FIG. 7 is a perspective view of a compression die press 700 for stepped porous transport layer (PTL) manufacturing. The compression die press 700 includes a compression block 702 configured to cooperate with a base die 704 to compress a perimeter of a porous transport layer (PTL) 706 forming a transition 708. The base die 702 and compression block 704 may be formed of a metal material, such as steel, hardened steel, stainless steel, titanium, titanium nitride (TiN), titanium carbonitride (TiCN), chromium nitride (CrN), or a combination thereof. The compression block 702 and the base die 704 may be configured to form a transition 708 between a perimeter edge thickness 710 and a uncompressed center edge portion 712 of the PTL 706. The transition 708 may be stepwise, slanted, linear, curved, or filleted.

Another method of fabricating a stepped porous transport layer or PTL includes sintering the metal (e.g., titanium-based or other metals) to form a metallic PTL in multiple layers with a multilayered sintering bed, resulting in a finished PTL with edge thickness less than that of the center area. The sintering bed includes filling with a number of layers that are formed of sintered, woven, meshed, and/or stretched metals such as Ti. The layers may have properties such as pore structure, pore modulus, grain size, particle size, fiber size, and metal type. Also, the sintering bed may be formed of one or more ceramic materials and/or high temperature metallic materials.

A multilayered sintering bed is shown in FIG. 8. In this configuration, metallic powders or the as-fabricated and cut PTLs are added to each layer of the sintering bed and sintered in a high temperature oven, allowing for a multilayer PTL structure to be formed, with a stepped edge with depth between 0 and 10 mm and a width between 0 and 100 mm.

The sintering bed includes filling with a number of layers that are formed of sintered, woven, meshed, and/or stretched metals.

FIG. 8 is a perspective view of a sintering bed 800 for stepped porous transport layer (PTL) manufacturing. The sintering bed is configured with a first area 802 bound by a first perimeter wall 804 having a first thickness that once material is deposited above, the material extends to a second area 806 bound by a second perimeter wall 808. The first perimeter wall 804 is configured to form a transition between the first area 802 and the second area 806. The transition between the first area 802 and the second area 806 may be stepwise, slanted, linear, curved, or filleted.

A further method includes a processing step that include mechanical shearing/cutting at the edges of the PTL. This can be accomplished with a stepped structure knife or shearing edge along with a perimeter compression area resulting in an edge thickness less than that of the uncompressed center area.

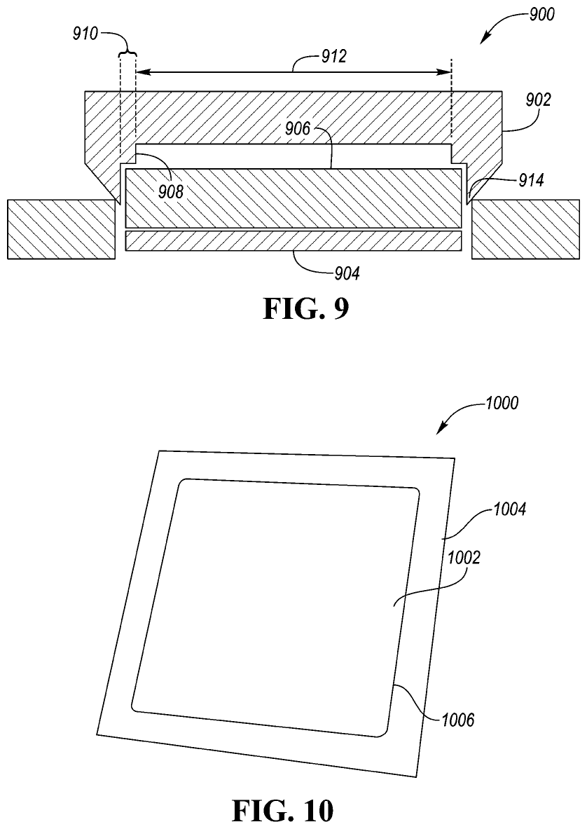

This disclosed method can create a porous transport layer(s) as shown in FIGS. 1, 2, 3, 4 and 5 with a transition profile as shown in FIGS. 6A-6D. A compression cutter may be used in a press, as shown in FIG. 9. In this configuration, the as-fabricated PTL is placed between the compression cutter and the PTL support and pressed until the edges of the PTL are cut to dimension, and the deformation from the step structure of the punch achieves the target depth, between 0 and 10 mm.

FIG. 9 is a perspective view of a stepped punch press for stepped porous transport layer (PTL) manufacturing. The compression die press 700 includes a compression cutter 902 configured to cooperate with a base die 904 to compress a perimeter of a porous transport layer (PTL) 906 forming a transition 908. The compression cutter 902 and base die 904 may be formed of a metal material, such as steel, hardened steel, stainless steel, titanium, titanium nitride (TiN), titanium carbonitride (TiCN), chromium nitride (CrN), or a combination thereof. The compression cutter 902 and the base die 904 may be configured to form a transition 908 between a perimeter edge thickness 910 and an uncompressed center edge portion 912 of the PTL 906. The transition 908 may be stepwise, slanted, linear, curved, or filleted. As the compression cutter 902 is pressed to the base die 904, a shearing edge 914 in corporation with the base die 904 shears or cuts the PTL 906. The edge 914 of the compression cutter 902 may be made of the same material as the compression cutter or it may be a different material configured to cut when acting with an edge of the base die 904.

FIG. 10 is a perspective view of a stepped porous transport layer (PTL) 1000 having an uncompressed region 1002, a compressed region 1004, and a transition 1006 therebetween. The uncompressed region 1002 has a greater porosity than that of the compressed region 1004.

When the PTL is formed of titanium, the PTL may be covered with a passivating layer formed of TiO₂ that is electrically insulating to protect the PTL from the high operating potential of the anode electrode and the oxygen rich environment. The electrically insulating layer may reduce the performance of the PEMEC. These performance losses may be reduced by further coating the PTL surface with a highly conductive noble metal (e.g., platinum or gold), but at a higher cost.

The embodiments disclosed herein provide electrolysis cells to reduce local current and degradation hot spots in electrolysis cells and/or to relieve mechanical stresses in electrolysis, thereby enhancing the performance of the electrolysis cell.

Referring to FIG. 5, in which an anode catalyst layer is deposited on the PTL surface morphology to form PTE 514 on PTL surface 536. PTE 536 has a PTE surface morphology. The deposition of the anode catalyst layer may be a surface decoration on PTL surface 536. The PTL surface morphology may include PTL pores where the anode catalyst material at least partially coats and/or occupies the PTL pores. The PTL surface morphology may include PTL pores having a PTL mean pore size and the PTE surface morphology may include PTE pores having a PTE mean pore size less than the PTL mean pore size.

The anode catalyst layer may include an anode catalyst material supported on an anode catalyst support. The anode catalyst material may be iridium (Ir), iridium oxide (IrOₓ), where x is in a range of 2 to 4, ruthenium (Ru), ruthenium oxide (RuOₓ), where x is in a range of 1.8 to 2.2, or a combination thereof. The anode catalyst material may be a crystalline material, an amorphous material, or a combination thereof. The anode catalyst support may be titanium (Ti), titanium oxide (TiO₂), or a combination thereof. The weight percent of the anode catalyst material to the anode catalyst support may be between 5 and 100 weight percent. In one or more embodiments, the anode catalyst layer consists essentially of an anode catalyst material of iridium (Ir), iridium oxide (IrOₓ), where x is in a range of 2 to 4, ruthenium (Ru), ruthenium oxide (RuOₓ), where x is in a range of 1.8 to 2.2, or a combination thereof.

In one or more embodiments, the anode catalyst layer is deposited onto the surface of the PTL such that it coats the exposed interface between the PTL and the PEM, thereby enhancing (e.g., maximizing) surface contact between the PTL and the anode catalyst layer. The enhanced surface contact provides a more distributed current to increase electron transport and decrease hot spot generation.

The anode catalyst material may also include an anode ionomer material. The anode ionomer material may be a perfluorinated sulfonic acid ionomer, a high oxygen permeable ionomer or ionomer with modified polymeric structures designed to enhance the free volume of the ionomer and enhance oxygen transport, a hydrocarbon ionomer, an ion conducting polymer, or a combination thereof. The mass fraction of the anode ionomer material in the anode catalyst layer may be between 0 and 50 percent.

The pores between the porous transport electrode (PTE) (e.g., the anode catalyst layer deposited on the PTL surface) and the PEM may be infiltrated with an ionomer material. For instance, the ionomer material may at least partially coat and/or occupy the PTE pores. The ionomer material may include a perfluorinated sulfonic acid ionomer, a high oxygen permeable ionomer or ionomer with modified polymeric structures designed to enhance the free volume of the ionomer and enhance oxygen transport, a hydrocarbon ionomer, an ion conducting polymer, or a combination thereof. The infiltrated ionomer may also include inert additives such as silica nanospheres, boronitride flakes, graphene oxide flakes, to reduce compression inside the pores of PTE.

In one or more embodiments, along with compression of the stepped PTL/PTE to provide structural stability, additionally infiltrating an ionomer material into the PTE pores between the PEM and anode catalyst material to improve proton conductivity and/or induce hydraulic pressure to reduce stress at the interface between the PEM and the PTL/PTE. These benefits may address the lack of mechanical support provided by the pores against the relatively high operational pressure difference between the anode and the cathode side of the MEA (e.g., up to 50 bara pressure differential in the electrolysis cell stack). In one or more embodiments, the ionomer material includes an ionomer. The ionomer may be a perfluorinated sulfonic acid ionomer, a high oxygen permeable ionomer, a hydrocarbon ionomer, an ion conducting polymer, or a combination thereof. The infiltrated ionomer may include a filler material bound to the ionomer. The filler material may be a silica nanosphere material silica nanospheres, polytetrafluoroethylene (PTFE) reinforcement, radical scavengers, recombination catalysts, boronitride flakes, graphene oxide flakes, or a combination thereof.

In one or more embodiments, the anode catalyst layer may be deposited as a thin layer on the PTL to form a PTE. Suitable deposition methods may include without limitation spray coating, vacuum infiltration, chemical vapor deposition, blade coating, hot-dipping, incipient witness techniques, and/or electrostatic deposition. In one or more embodiments, the ionomer and filler infiltration into the PTL and/or PTE may be accomplished by spray coating, vacuum infiltration, blade coating, and/or hot pressing. The combined structure of the PTL, anode, and infiltrated ionomer may be incorporated with the membrane (e.g., catalyst coated membrane) via a binding method (e.g., hot pressing) or raw assembly into an MEA.

In another embodiment of a PTE, an anode electrode structure may be configured to enhance (e.g., maximize) catalyst utilization by selectively depositing anode catalyst material only in areas of the PEM that are in direct contact with PTE.

Due to the porosity of the PTL surface facing the PEM that includes a PTL surface morphology. An anode catalyst layer is deposited on the PTL surface morphology to form contact regions (e.g., localized anode catalyst layer portions) between PEM and PTL. With the porosity, the PTL also includes noncontact regions between the contact regions along the PTL surface morphology. Noncontact regions may be spaced apart from PEM forming gaps that extend from PEM to PTL in which the anode catalyst layer may only reside in the contact regions.

Although not shown, the PTL may further include a microporous layer (MPL) contacting PTL surface and anode catalyst layer portions. The MPL has an MPL surface morphology. The anode catalyst layer may be deposited on the MPL surface morphology and/or the PTL surface morphology to form the contact regions.

The anode catalyst layer that forms localized catalyst layer portions 152 may include an anode catalyst material supported on an anode catalyst support. The anode catalyst material may be iridium (Ir), iridium oxide (IrOₓ), where x is in a range of 2 to 4, ruthenium (Ru), ruthenium oxide (RuOₓ), where x is in a range of 1.8 to 2.2, or a combination thereof. The anode catalyst material may be a crystalline material, an amorphous material, or a combination thereof. The anode catalyst support may be titanium (Ti), titanium oxide (TiO₂), or a combination thereof. The weight percent of the anode catalyst material to the anode catalyst support may be between 5 and 100 weight percent. In one or more embodiments, the anode catalyst layer consists essentially of an anode catalyst material of iridium (Ir), iridium oxide (IrOₓ), where x is in a range of 2 to 4, ruthenium (Ru), ruthenium oxide (RuOₓ), where x is in a range of 1.8 to 2.2, or a combination thereof.

The anode catalyst material may also include an anode ionomer material. The anode ionomer material may be a perfluorinated sulfonic acid ionomer, a high oxygen permeable ionomer or ionomer with modified polymeric structures designed to enhance the free volume of the ionomer and enhance oxygen transport, a hydrocarbon ionomer, an ion conducting polymer, or a combination thereof. The mass fraction of the anode ionomer material in the anode catalyst layer may be between 0 and 50 percent.

In one or more embodiments, a method of forming an electrolysis cell including anode catalyst layer portions 514 portions is disclosed. The method may include selectively depositing an anode catalyst layer onto a PTL or the surface morphology of a PTL. The anode catalyst layer is configured to form contact regions between the anode catalyst layer, the PTL, and the PEM. The PTL includes noncontact regions between the contact regions along the PTL surface morphology.

The anode catalyst layer may be deposited onto the contact regions via partial submersion in a plating solution, a liquid masking technique, brush painting, blade coating, rod coating, roller-deposition, etc. The method may further include preheating the PTL surface morphology to block noncontact regions.

The selectively depositing step may be carried out using a direct application step including directly applying a catalyst medium to the PTL, an indirect application step, or a synthesis step. The directly applying step may be carried out using brush painting, blade coating, rod coating, or dipping. The catalyst medium may be a catalyst medium ink or a catalyst medium powder. The indirect application step may include fabricating the anode catalyst layer on a substrate to obtain a fabricated anode catalyst layer and transferring the fabricated anode catalyst layer onto the PTL surface morphology. The indirect application step may be carried out using decal transfer, calendaring, hot pressing, electrostatic transfer, and/or melting. The synthesis step may include synthesizing the anode catalyst layer onto the PTL surface morphology using direct reduction, electro-plating, and/or incipient wetness.

Also, according to one embodiment of an anode PTL that enhances (e.g., maximizes) electrical conduction through the PTL by selectively depositing a PTL coating (e.g., a conductive and corrosion resistant metal) in areas of the PTL that are in direct contact with a current collector. This corrosion resistant material coated onto the PTL may be fractions of a micron. The PTL coating may have a mean thickness of 5 nm to 0.7 μm.

The PTL may be formed of a metal foam material, a porous metal sheet material, or a metal felt material. The porous metal sheet material may be formed from sintered metal particles.

The PTL coating may be formed of a conductive metal configured to resist corrosion. The conductive metal may be a noble metal. A noble metal is a metal that has a high resistance to corrosion and oxidation including Ru, Rh, Pd, Os, Ir, Pt, Au, and Ag. Preferred metals may be Ir, Pt, Au, or a metal alloy or a combination thereof.

The selectively depositing step may include transferring the PTL coating onto the PTL surface morphology. The transferring step may be carried out with electroless deposition, electrodeposition and/or vapor deposition. The PTL coating may be deposited via partial submersion in a plating solution or a liquid masking technique.

The depositing method may further include pretreating the PTL surface morphology to remove a passivating layer from the contact regions prior to the selective depositing step. The depositing method may comprise pretreating the PTL surface morphology to block the noncontact regions.

In connection with one or more of these methods, the current collection may include a flow field plate including lands and channels collectively forming a flow field. In one or more embodiments, the noncontact regions include (a) pores embedded in the PTL surface morphology and/or (b) regions aligning with the channels of the flow field plate.

The following applications are related to the present application: U.S. patent application Ser. No. ______ filed on ______, ______ (RBPA0539PUS), U.S. patent application Ser. No. ______ filed on ______, ______ (RBPA0540PUS), U.S. patent application Ser. No. ______ filed on ______, ______ (RBPA0542PUS), and U.S. patent application Ser. No. ______ filed on ______, ______ (RBPA0543PUS), all of which are incorporated by reference in their entirety.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of manufacturing a porous transport layer (PTL) for an electrochemical cell, the method comprising:
filling a sintering bed with a powder substance, wherein the sintering bed has a top face profile; and
applying heat to the sintering bed and the powder substance to form the PTL from the powder substance, the PTL having a first porosity in a first region and a second porosity in a second region, the first porosity is greater than the second porosity.

2. The method of claim 1, wherein filling the sintering bed further includes filling with a number of layers that are formed of sintered, woven, meshed, and/or stretched metals.

3. The method of claim 2, wherein filling the sinter bed with the sintered, woven, meshed, and/or stretched metals include titanium.

4. The method of claim 3, wherein the number of layers share a property.

5. The method of claim 4, wherein the property is at least one of pore structure, pore modulus, grain size, particle size, fiber size, and metal type.

6. The method of claim 1, wherein the sintering bed is formed of one or more ceramic materials and/or high temperature metallic materials.

7. The method of claim 1, wherein the sinter bed has a stepped edge that is configured to form a transition between the first region and the second region.

8. The method of claim 7, wherein the transition is stepwise, slanted, linear, curved, or filleted.

9. The method of claim 8, wherein the transition is on one or more sides of the PTL form a 3D structure.

10. A porous transport layer (PTL) sintering bed comprising:
a first dimensional layer thickness; and
a second dimensional layer thickness, the first dimensional layer thickness and the second dimensional layer thickness are cooperatively configured to form a PTL with a perimeter edge thickness less than a center portion thickness of the PTL.

11. The PTL sintering bed of claim 10, wherein the sintering bed is formed of one or more ceramic materials and/or high temperature metallic materials.

12. The PTL sintering bed of claim 11, wherein a stepped edge provides a transition between the first and second dimensional layer thickness.

13. The PTL sintering bed of claim 12, wherein a width of the stepped edge of the sintering bed is 0 to 100 mm.

14. The PTL sintering bed of claim 13, wherein a depth of the stepped edge of the sintering bed is 0 to 10 mm.

15. The PTL sintering bed of claim 14, in which the stepped edge of the sintering bed forms a transition profile that is at least partially stepwise, slanted, linear, curved, or filleted.

16. The PTL sintering bed of claim 15, wherein the transition profile is on one or more sides of the PTL.

17. The PTL sintering bed of claim 16, wherein the transition profile is in one or more sections of a perimeter of the PTL to form a three-dimensional structure.

18. A method of manufacturing a porous transport layer (PTL) for an electrochemical cell, the method comprising:
filling a sintering bed with a powder substance, wherein the sintering bed has a top face profile; and
applying heat to the sintering bed and the powder substance to form the PTL from the powder substance, the PTL having a first thickness in a first region and a second thickness in a second region, the first thickness is greater than the second thickness.

19. The method of claim 18, wherein the sinter bed has a stepped edge that is configured to form a transition between the first region and the second region, and the transition is stepwise, slanted, linear, curved, or filleted.

20. The method of claim 19 further comprising coating a corrosion resistant layer to a top face and a second bottom face of the PTL.
